(19) United States
(12) Patent Application Publication
(10) Pub. No.: US 2014/0203191 A1
(43) Pub. Date: Jul. 24, 2014

(54) Method of Observing Samples with a Fluorescent Microscope

(71) Applicant: FEI Company, Hillsboro, OR (US)

(72) Inventors: Bart Buijsse, Eindhoven (NL); Linda Francina van Driel, Best (NL)

(73) Assignee: FEI Company, Hillsboro, OR (US)

(21) Appl. No.: 14/160,135

(22) Filed: Jan. 21, 2014

Related U.S. Application Data
(60) Provisional application No. 61/755,106, filed on Jan. 22, 2013.

(30) Foreign Application Priority Data
Jan. 22, 2013 (EP) 13152215.3

(51) Int. Cl. G01N 21/64

(52) U.S. Cl. CPC G01N 21/6458
USPC 250/459.1; 250/458.1

(57) ABSTRACT

The invention relates to a method of inspecting parts of a sample on a TEM grid with a fluorescence microscope, as arises when performing correlative microscopy, more specifically for samples on a holey carbon grid. A problem occurs when imaging vitrified ice with sample material when the ice is heated by the light used. The invention is based on the insight that the absorption in the carbon support film is responsible for the heating, as ice hardly absorbs light. By localizing the illumination of the fluorescent microscope to the parts of the sample that are above a hole in the carbon, heating of the ice is lowered. The localization can be achieved by, for example, passing the light through a LCD type Spatial Light Modulator.

This Application claims priority from U.S. Provisional Application No. 61/755,106, filed Jan. 22, 2013, which is hereby incorporated by reference.

The invention relates to a method of inspecting parts of a sample with a fluorescence microscope, at least part of the sample supported by a supporting carbon film, the fluorescence microscope illuminating the sample with excitation light to generate fluorescence or phosphorescence, said sample vulnerable to damage by a temperature rise, the supporting carbon film showing holes or thickness variations.

Such a method is known from SCHWARTZ, Cindi L et al., ‘Cryo-fluorescence microscopy facilitates correlations between light and cryo-electron microscopy and reduces the rate of photobleaching’, J. Microsc. 2007 August 227 (Pt 2), pp 98-109.

The known method describes that in a setup for cryo-fluorescence microscopy a cryogenic vitrified sample is irradiated with light, and the fluorescence is observed.

Cryogenic vitrified samples are, for example, biological samples that are frozen to arrest a sample in a given state. The formation of ice crystals during the freezing should be avoided as these crystals damage the structures of the sample, for example by puncturing cell membranes. Crystallization is avoided by freezing the sample to a temperature below the glass transition temperature of water of approximately 130 K at an ultra-high cooling rate, for example in the range of 10⁵ K/s, or by cooling it by a combination of a high cooling rate and high pressure (10³ K/s@2000 bar). These are techniques known per se, and described in e.g. US patent document U.S. Pat. No. 7,413,872 B2 and US patent document U.S. Pat. No. 6,758,362 B2, and (possibly after the use of for example a cryo-microtome) result in a sample with a typical thickness of 1 μm or less.

It is known that, when exposing the sample to light, the response of fluorescent markers to light diminishes over time. This is known as photo-bleaching. It is noted that the effect of photo-bleaching is less pronounced at cryogenic temperatures than at room temperature.

After observing the sample with a light microscope and observing the fluorescence, the sample may be inspected in a Transmission Electron Microscope (TEM) for observing details with a resolution down to 10 nm or less. Therefore the samples are typically prepared on a TEM support grid. A TEM support grid is available from, for example, TED PELLA Inc., Redding, Calif., USA, see http://wwwtedpella.com/supflm_html/suptfilm.htm.

A popular type of grid is the so-named holey carbon grid, in which a carbon support film is used, the carbon support film showing holes. Sample material suspended over the holes and embedded in ice can be inspected with for example transmitted electrons without interference (diffraction) of the carbon support film. It is noted that also holey carbon grids are known where the holes are not through-holes, but very thin carbon films of, for example, 3 nm or less.

It is noted that it is known to make not a 2D image of the sample in the TEM, but a 3D tomogram. This is described in e.g. SARTORI, Anna et al., ‘Correlative microscopy: Bridging the gap between fluorescence light microscopy and cryo-electron tomography’, J. Struct. Biol. 160 (2007), p. 135-145. This results in a 3D image of the sample, instead of a 2D image.

During fluorescence microscopy intense illumination is desired, such that the fluorescent signal can be collected in short time periods. This is advantageous in terms of signal-to-noise (the noise during a short period is less than the noise during a long period), but also to minimize specimen drift during detection. Also the ease of use is improved this way, quick availability of a high quality image is advantageous for searching and focusing onto an area of interest.

A problem when using intense illumination is that heating may occur, damaging or destroying the specimen.

The invention intends to provide a solution to heating when using intense illumination.

To that end the method according to the invention is characterized in that
the supporting carbon film shows holes or thickness variations resulting in position dependent absorbance of the excitation light, resulting in parts with a high absorption of the excitation light and parts with a low absorption of the excitation light,
the parts of the sample to be inspected are located over holes or parts of the supporting film with a low absorption of the excitation light; and
the illumination is localized such that the parts of the supporting film with a high absorption of the excitation light and bordering the parts of the sample to be inspected are not illuminated.

Obviously the heating is caused by absorption of the excitation light. The invention is based on the insight that the absorption of this light by a thin sample is often negligible, but that absorption by carbon is not. As an example: vitrified ice absorbs only very little light The heat that is generated in the carbon reaches the sample area by thermal conduction and in this way causes a temperature rise of the sample. The absorbance of thin carbon films is described in e.g. LARSON, D. M., et al., ‘The surface of evaporated carbon films is an insulating, high-bandgap material.’, J. Struct. Biol. (2011).

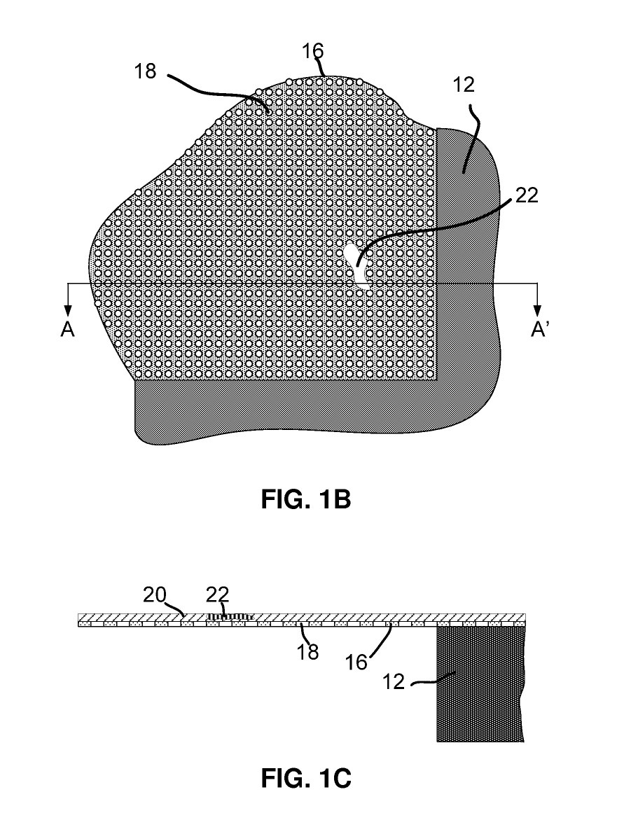

Absorbance is described in terms of optical density, in which the optical density A(λ) is defined as A(λ)=log₁₀(l₀/l₁), with l₀ the amount of impinging light and l₁ the amount of transmitted light. LARSON shows in FIG. 2 that for a film thickness of more than 5 nm in close approximation A(λ)=[(D−5)×0.016] nm⁻¹ with D the thickness of the carbon film in nm. In other words: a layer of 11 nm of carbon already has an optical density A(λ)=0.1 and thus absorbs 21% of the impinging light, and a layer of 65 nm absorbs approximately 90% of the impinging light (A(λ)=1).

A typical absorption figure of ice is of the order of 0.1 m⁻1 in the 300-600 nm domain, and—assuming there is an absorbing carbon layer—this is thus negligible compared to the absorption by a carbon layer.

By using grids showing holes or thickness variations resulting in position dependent absorbance of the excitation light, and restricting inspection with intense illumination to areas of interest that are positioned over parts where the grid shows no or little absorbance, and avoiding illumination of the parts of the supporting film with a high absorption of the excitation light and bordering the parts of the sample to be inspected (positioned over the areas with low or no optical absorbance), dissipation due to intense illumination is avoided. As a result intense illumination can be used without damaging the sample.

It is noted that these effects are very notable when studying vitrified cryogenic samples, where a temperature rise results in crystallization and/or sublimation and thus damage of the sample.

It is noted that the person skilled in the art will understand that parts of the film far removed from the area of interest, that is: parts where heating (resulting in for example crystallization or sublimation) is allowed, may be illuminated by intense light, even if those parts show high absorbance. Also parts that are in directs contact with, for example, a copper mesh of the grid (or a material showing high thermal conductivity) may be illuminated without ice crystallization occurring.

It is further noted that the whole sample may be exposed to a low light level, for example to determine where the borders between low and high absorbance are, as long as this does not result in a rise of temperature where damage occurs (for example such a temperature increase that ice crystallization occurs).

Note that the temperature rise of a film not only depends on the absorbed light but also on the thermal conductivity of the film. Although a thinner film absorbs less light than a thick film, the thermal conduction of the thinner film also decreases and as a result the temperature rise can still be very high.

Localization of the illumination can be achieved in several ways: by rastering a beam of light over the sample combined with intensity modulation of said beam, by vectoring the beam of light, or by illuminating the sample with a broad beam of light that passed through for example a spatial light modulator (SLM). An SLM is known per se and is used to vary the phase and/or amplitude of the transmitted light. An example of its use is, for example, in LCD projectors.

It is noted that the use of a SLM in the optical illumination system of a FM is known and described in US patent no. U.S. Pat. No. 7,884,337 B2. However, the SLM is here used to locally modulate the phase of the excitation light and does not vary the amount of impinging light on the sample (the intensity of light impinging on the sample).

It is important to realize that any other material that might be considered as a support film, as an alternative to carbon, is likely to have the same high absorbance as carbon. This is related to the wish to have a support film that is electrically conducting. Materials that are electrically conducting usually have a high optical absorbance.

The combination of FM with TEM results in a powerful correlative microscopy, in which information of two different microscopy techniques are combined. The FM locates the areas with fluorescent markers (such as Green Fluorescent Protein [GFP] or an immuno-label), while TEM can be used for much higher resolution and locating heavy metal markers. Also FM can locate large structures and identify areas of interest to be inspected in the TEM at much higher magnification.

Preferably the inspection is performed in an instrument comprising a FM mounted on the evacuable sample chamber of a TEM. Such instruments are commercially available as ‘Tecnai with iCorr’ from FEI Co., Hillsboro, USA.

In an aspect of the invention an apparatus including a fluorescent microscope equipped with an illumination system to illuminate a vitrified sample with excitation light, and a detector for detecting fluorescent light emerging from the sample, the illumination system comprises a spatial light modulator for modulating the intensity of the excitation light, and the fluorescence microscope comprises a controller to control the spatial light modulator to localize the illumination is characterized in that the apparatus further comprises an electron microscope column.

By equipping the illumination system of a fluorescence microscope with a spatial light modulator for modulating the intensity of the excitation light on the sample, and adding a controller for said spatial light modulator to the fluorescence microscope, the method described previously can be performed.

This is combined with an electron microscope column, preferably with a transmission electron microscope column.

The apparatus should be equipped with means to keep the sample at a cryogenic temperature.

The invention is now elucidated using figures, where identical reference numerals identify corresponding features. To that end:

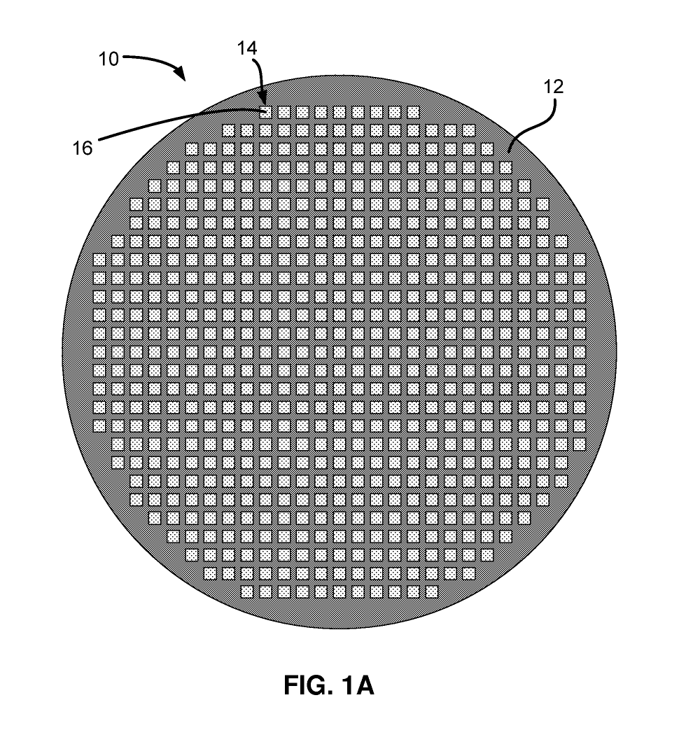

FIG. 1A schematically shows a top view of a TEM grid;

FIG. 1B schematically shows a detail of FIG. 1A; and

FIG. 1C schematically shows a cross-section of the detail shown in the FIG. 1B.

FIG. 1A schematically shows a top view of a TEM grid.

The TEM grid 10 is a circular thin copper foil 12 with a thickness of approximately 25 μm and a diameter of 3.05 mm. The foil shows a large number of holes 14 (for example 400 per inch) and a thin film of carbon 16 on which a sample can be placed. The copper and carbon not only provide support, but also electrical conductivity to avoid charging.

It is noted that grids with a coarser or finer mesh are known, other materials (gold, nickel, (carbon coated) plastic), other forms of the holes (slots, hexagons), or forms differing from the thin circular foil (see e.g. U.S. Pat. No. 7,767,979 and U.S. Pat. No. 7,034,316).

It is further noted that the holes may show a thin layer of carbon, for example a layer of 3 nm. This is according to LARSON insufficient to absorb light or to provide an electrically conductive path from the sample to ground (the holder of the grid).

The film need not be a carbon film, essential for the invention is that the film is an absorbing film, and that the absorption is avoided by not illuminating the parts of the foil where illumination leads to heat dissipation.

FIG. 1B schematically shows a detail of FIG. 1A,

FIG. 1B schematically shows a bar of the copper foil 12, the carbon film 16 and a large number of holes 18 in the carbon film. Over the carbon film and the holes a vitrified sample 22 in vitrified ice is provided.

FIG. 1C schematically shows a cross-section along line AA′ of the detail shown in FIG. 1B.

FIG. 1C schematically shows a cross-section of a part of a copper bar 12, and carbon foil 16. Foil 16 shows a large number of holes 18. On top of the carbon film 16 a layer of vitrified ice 20 is shown, in which a sample 22 is present. An area of interest would thus be the part of the sample 22 that is located over a hole.

When illuminating the grid with intense light, the holes 18 are illuminated and the parts surrounding (bordering) the holes are not illuminated.

It is noted that the copper foil can also be another material, for example nickel, gold, (carbon coated) plastic, etc. It is further noted that the holes may show a thin layer of carbon, for example a layer of 3 nm. This is according to LARSON insufficient to absorb light or to provide an electrically conductive path from the sample to ground (the holder of the grid).

It is further noted that, although the invention is only explained on the hand of a vitrified cryogenic sample, similar effects occur when studying, for example, chemical processes just below the temperature of a phase change, or when studying for example proteins.

It is mentioned that localized illumination can be used in other applications as well, where illumination outside given boundaries, or avoiding certain areas, is demanded.

### NON-PATENT LITERATURE

[-1-] SCHWARTZ, Cindi L. et al.; ‘Cryo-fluorescence microscopy facilitates correlations between light and cryo-electron microscopy and reduces the rate of photobleaching’, J. Microsc. 2007 August 227 (Pt 2), pp 98-109.

[-2-] Internet catalogue TED PELLA, Redding, Calif., USA, http://www.tedpella.com/supflm_html/suptfilm.htm, created Jan. 21, 2013.

[-3-] SARTORI, Anna et al., ‘Correlative microscopy: Bridging the gap between fluorescence light microscopy and cryo-electron tomography’, J. Struct. Biol. 160 (2007), p. 135-145.

[-4-] LARSON, D. M. et al., ‘The surface of evaporated carbon films is an insulating, high-bandgap material.’, J. Struct. Biol. (2011).

1. A method of inspecting parts of a sample with a fluorescence microscope, at least part of the sample supported by a supporting carbon film, the fluorescence microscope illuminating the sample with excitation light to generate fluorescence or phosphorescence, said sample vulnerable to damage by a temperature rise, the supporting carbon film showing holes or thickness variations, wherein:
the supporting film showing holes or thickness variations results in position dependent absorbance of the excitation light, resulting in parts with a high absorption of the excitation light and parts with a low absorption of the excitation light,
the parts of the sample to be inspected are located over holes or parts of the supporting film with a low absorption of the excitation light; and
the illumination with excitation light is a localized illumination, the localization such that the parts of the supporting film with a high absorption of the excitation light and bordering the parts of the sample to be inspected are not illuminated with excitation light.

2. The method of claim 1 in which the localization of the illumination is achieved by scanning a beam of excitation light over the sample and modulating the intensity of said beam.

3. The method of claim 1 in which the localization of the illumination is achieved by vector scanning a beam of excitation light over the sample.

4. The method of claim 1 in which the localization of the illumination is achieved by passing the excitation light through a spatial light modulator causing intensity modulation.

5. The method of claim 4 in which the spatial light modulator is an LCD type spatial light modulator imaged on the sample.

6. The method of claim 1 in which the sample is a vitrified cryogenic sample.

7. The method of claim 1 in which the parts with a high absorption absorb more than 1%, and the parts with a low absorption absorb less than 1% of the excitation light.

8. The method of claim 7 in which the parts with a high absorption comprise a layer with at least 5 nm of carbon and the parts with a low absorption comprise a layer with at most 5 nm or no carbon layer at all.

9. The method of claim 1 in which prior to illuminating the sample to excite the sample while detecting fluorescence or phosphorescence, an image is taken with reflected or transmitted light to determine the borders of the supportive carbon film.

10. The method of claim 1 in which the method further involves imaging the sample in a transmission electron microscope.

11. The method of claim 10 in which the transmission electron microscope is equipped with a sample chamber and the fluorescent image and the electron optical image are both acquired while the sample is on the sample chamber of the transmission electron microscope.

12. An apparatus including a fluorescent microscope equipped with an illumination system for illuminating a vitrified sample with excitation light, and a detector for detecting fluorescent radiation emerging from the sample, the illumination system comprises a spatial light modulator for modulating the intensity of the excitation light, the fluorescent microscope comprises a controller to control the spatial light modulator to localize the illumination, wherein:
the apparatus further includes an electron microscope.

13. The apparatus of claim 12 in which the apparatus is equipped with means to keep the sample at a cryogenic temperature.

14. The apparatus of claim 13 in which the electron microscope column is a transmission electron microscope column.

15. The method of claim 7 in which the parts with a high absorption comprise a layer with at least 11 nm of carbon and the parts with a low absorption comprise a layer with at most 5 nm or no carbon layer at all.

16. The method of claim 7 in which the parts with a high absorption comprise a layer with at least 65 nm of carbon and the parts with a low absorption comprise a layer with at most 5 nm or no carbon layer at all.

17. The method of claim 1 in which the parts with a high absorption absorb more than 10% of the excitation light, and the parts with a low absorption absorb less than 1% of the excitation light.

18. The method of claim 1 in which the parts with a high absorption absorb more than 90% of the excitation light, and the parts with a low absorption absorb less than 1% of the excitation light.
